(19) United States
(12) Patent Application Publication
(10) Pub. No.: US 2005/0149495 A1
(43) Pub. Date: Jul. 7, 2005

(54) Method and apparatus for storing and retrieving items

(75) Inventor: Leslie M. Goldschlager, Malvern (AU)

Correspondence Address: STITES & HARBISON PLLC, 1199 NORTH FAIRFAX STREET, SUITE 900, ALEXANDRIA, VA, 22314, US

(73) Assignee: Riversdale Distributors PTY. LTD., Melbourne (AU)

(21) Appl. No.: 10/507,154

(22) PCT Filed: Mar. 24, 2003
(86) PCT No.: PCT/AU03/00355

Related U.S. Application Data
(60) Provisional application No. 60/367,207, filed on Mar. 26, 2002.

(51) Int. Cl. G06F 7/00

(52) U.S. Cl. 707/3

(57) ABSTRACT

The invention provides a method and apparatus for storing and retrieving items, the method comprising: grouping the items into one or more groups of the items; recording the content of each of the groups; comparing a batch of one or more orders for the items with the recorded content of the groups in order to locate a matching group from the groups that matches the batch or orders; and retrieving the matching group in order to fill the batch of orders.

### FIELD OF THE INVENTION

The present invention relates to a method and apparatus for storing and retrieving items such as goods, and is of particular but by no means exclusive application in storing and retrieving goods in preparation for dispatching those goods from, for example, a mail-order distribution centre, or for storing returned goods.

### BACKGROUND OF THE INVENTION

Existing methods for storing or sorting goods typically emphasise the need to sort goods according to type, so that like goods are stored together and then retrieved according to type for dispatch. “Type” can refer to the nature of the goods (e.g. books verses compact disks), or some more specific characteristic (e.g. a specific pair of shoes in size 40 verses the same shoes but in size 42).

U.S. Pat. No. 5,900,610 for example, discloses a method and apparatus for tracking an inventory for goods having a variety of styles and characteristics, and which have a variety of possible shipping destinations. This document teaches a multi-part label that is attachable to each of the goods and has a removable portion that can be detached from the original label and reapplied to a shipping carton for a collection of goods. It is claimed that, in conjunction with an inventory distribution system, it is thereby possible to keep track of the location of all goods at any time between sorting the goods for shipment and packing the goods for shipment.

In the same vein, U.S. Pat. No. 4,835,702 discloses a method of sorting goods into groups which have been determined in advance in the order of delivery in a prescribed quantity, so as to allow sequential loading of goods in a truck or the like in a “first-in-last-out” manner. The disclosed method anticipates that the loading order is dependent on the nature and quantity of items for a particular destination, and employs a system of assembling and storage conveyors for assembling goods in classified groups, a diverting conveyor for sorting out goods and a controlling system for controlling the converting conveyor and the sorting out operation.

It is not suggested that any of the above existing systems form a part of a common general knowledge and, in any event, they share the common characteristic of assuming that goods are stored by type, and retrieved strictly in response to a received order.

### SUMMARY OF THE INVENTION

According to a first aspect of the present invention, there is provided a method of storing and retrieving items, comprising:
grouping said items into one or more groups of said items;
recording the content of each of said groups;
comparing a batch of one or more orders for said items with the recorded content of said groups in order to locate a matching group from said groups that matches said batch or orders; and
retrieving said matching group in order to fill said batch of orders.

Thus, rather than storing the items according to their type and then creating, according to demand, groups of items according to received batches of orders, the items are stored essentially randomly (such as, for example, based on how those items are initially received), and simply matched with received batches of orders as those orders are received. The grouping of the items is performed either when the items are received from any source, such as the manufacturer, a distributor, or otherwise. For example, if goods are returned by a purchaser (such as during an approval period, as commonly employed in mail-ordering arrangements, or after a rental period), such items can be grouped in the same manner. It will be readily apparent that the sequence in which returned items are received is particularly randomized, and that the groups resulting therefrom can generally be expected to contain a large variety of items.

The greater the number of groups of items, the greater the probability that—for any random batch of orders—a group will have been created that matches the batch of orders. Thus, this method allows items to be stored without conventional sorting, while retaining the ability to fill most if not all batches of orders. It will be understood that the method can also be of value where the batch size is one, if—for example—each order can specify more than one item. In such cases, the method is, in effect, comparing a single order for multiple items with the existing groups of items.

The groups of items may constitute a plurality of sets of groups, each set of groups comprising one or more groups of equal numbers of items. Preferably, however, each of said groups has the same number of items.

For example, the items might be sorted into seven groups each of twenty items, ten groups each of twenty-five items, fifteen groups each of fifteen items, etc.

Preferably said batch of orders comprises a consecutively received plurality of orders.

Preferably the method includes locating each of said groups of items in or on a container, such as a tray, so that each of said groups can readily be transported, such as for storage, until a suitable batch of orders is received, and retrieved when a suitable batch of orders has been received.

The storage location for each group of items could be a set of pigeonholes on a shelf, or—in a computer controlled storage environment—a defined location in the storage system. A container will not always be needed. For example, when handling items such as disks, the location could contain spindles onto which the disks are stored in the sequence in which they are received.

Preferably the method includes recording the order of said items in each of said groups, and matching said batch of orders with a matching group on the basis of both the content and sequence of items in said order and in said matching group of said items.

This allows items to be efficiently dispatched—item 1 to request 1, item 2 to request 2, and so on.

In one embodiment, if none of the existing groups of items matches a batch of orders, the method includes reducing the size of said batch of orders until said reduced batch matches a portion of at least one of said groups of items, and deeming said portion of said group of items to constitute said matching group. Preferably, under these circumstances, the remaining items of said group are subsequently grouped with other items to form new groups of said items.

Alternatively, if none of the existing groups of items matches a batch of orders, the method includes replacing at least one of said orders with another order from outside said batch of orders to form a modified batch of orders, and then matching said modified batch of orders with a matching group on the basis of both the content and sequence of items in said order and in said matching group of said items.

In this last embodiment, the ejected order would then be used in forming a subsequent batch or orders.

Preferably said method includes optimising the size of said groups.

This can be done based either on preliminary studies, or from experience during actual use of the method. It is expected that optimising the group size would include striking a balance between the desirability of small group size (in order to increase the probability of matching any particular batch of orders) and maximising the size of each group (to minimise the number of groups requiring individual processing and handling). Depending on the nature of the items and the size of the operation, it is expected that over time an optimal group size or sizes would be ascertained. The most appropriate group size depends in part on the percentage of requests that are likely to be fulfilled by the selection of a random set of items.

The method can be used in conjunction with a computer system where a manifest of the incoming items and the location in which they were placed is stored in the computer system. The items can be individually identified—such as by means of barcodes—so as to more efficiently create a manifest of the incoming items.

According to a second aspect of the present invention, there is provided a method of storing and retrieving items, comprising:
grouping said items into one or more groups of said items;
recording the content of each of said groups;
comparing a batch of orders for said items with the recorded content of said groups in order to locate a matching group from said groups that most closely matches said batch or orders;
retrieving said matching group; and
modifying said matching group if necessary to exactly match said batch of orders;
whereby said batch of orders can be filled.

Thus, rather than insisting that a group of items be found that exactly matches the batch of orders, merely the closest match can be found and—if necessary—that group can be modified to form an exact match.

The present invention also provides an apparatus for storing and retrieving items, comprising:
data storage means for recording the location and content of each of a plurality of groups of said items;
data processing means for receiving information corresponding to a plurality of orders and for grouping at least some of said orders into a batch of orders and comparing said batch of orders with said contents of said groups of items in order to identify and locate a matching group; and
communication means for communicating the identity of said matching group.

Preferably said apparatus includes retrieval means for receiving the identity of said matching group from said communication means and retrieving said matching group.

The retrieval means can be any suitable device for retrieving the matching group from storage location, such as a mechanized, computer controlled trolley or sorting/retrieval device.

Preferably said retrieval means is also a storage means, for storing each of said groups of items as directed by said data processing means.

According to a third aspect of the present invention, there is provided a method of storing and retrieving items, comprising:
storing said items into one or more groups of said items;
recording the location of each of said items according to at least group;
comparing an order or orders for a plurality of requested items with said recorded locations; and
locating as many of said requested items as possible in a first of said groups and then, if any requested items are not located in said first of said groups, locating as many previously remaining requested items as possible in each of subsequent ones of said groups;
whereby once all of said requested items have been located, requested items can be retrieved to fill said order or orders.

Preferably said method includes retrieving said requested items and subsequently treating said retrieved items as no longer stored in any of said groups.

Any of the groups can constitute the “first” group, though in one embodiment the group with the greatest number of the requested items is designated the first group. This may, in some cases, minimize the total number of groups that must be drawn upon for items, possibly even to only one (i.e. the first) group.

The groups may then be checked sequentially for previously unlocated items, or in an order that maximizes the number of items located in each successive group.

In one embodiment, the method includes determining for a (preferably) large number of possible assignations of said first group and order of subsequent groups, and more preferably all of said possible assignations of said first group and order of subsequent groups, the total number of groups required to locate all of said requested items, and choosing the assignation of first group and order of subsequent group that either minimizes the total number of groups from which the requested items are retrieved or minimizes the distance required to be travelled between groups to retrieve said requested items.

Thus, it may be desirable to minimize the number of groups used, or the distance that an operator (human or mechanical) must travel to retrieve the items.

According to a fourth aspect of the present invention, there is provided an apparatus for storing and retrieving items, comprising:
one or more storages, each for storing a respective group of said items;
a data storage for recording the location of each of said items according to at least group;
a data processor for comparing an order or orders for a plurality of requested items with said recorded locations, and for locating as many of said requested items as possible in a first of said groups and then, if any requested items are not located in said first of said groups, locating as many previously remaining requested items as possible in each of subsequent ones of said groups;
whereby said apparatus is operable to locate all of said requested items for subsequent retrieval.

Preferably said apparatus includes a computer having said data storage and said data processor.

Preferably each of said storages (such a disk carousels) includes a signal means to identify to a user the location of a located item, or an ejector for ejecting (partially or fully) a requested item.

The signal means may be a lamp (such as an LED).

Alternatively, the apparatus may be operable to send a data signal to an automated (e.g. mechanical) item retriever indicative of the location of a respective requested item, so that said requested items can be retrieved automatically.

The data processor may be operable to check groups sequentially for previously unlocated items, or in an order that maximizes the number of items located in each successive group.

In one embodiment, the data processor is operable to determine a large number of possible assignations of said first group and order of subsequent groups, and preferably all of said possible assignations of said first group and order of subsequent groups, the total number of groups required to locate all of said requested items, and to choose the assignation of first group and order of subsequent group that either minimizes the total number of groups from which the requested items are retrieved or minimizes the distance required to be travelled between groups to retrieve said requested items.

The invention also provides a computer readable medium with computer program portions for controlling a computer to perform any of the above described methods.

### BRIEF DESCRIPTION OF THE DRAWINGS

In order that the present invention may be more clearly ascertained, preferred embodiments will now be described, by way of example, with reference to the accompanying drawings, in which:

FIG. 1 is a flow chart depicting an order fulfillment method according to a first preferred embodiment of the present invention;

FIG. 2 is a view of a tray for containing compact disks, for use with the method of FIG. 1;

FIG. 3 is a view of the tray of FIG. 2, filled with compact disks;

FIG. 4 is a view of an array of carousels for containing compact disks or DVD (™) disks, for use with an order fulfillment method according to a further preferred embodiment of the present invention; and

FIG. 5 is a view of one of the carousels of the array of carousels of FIG. 4.

### DETAILED DESCRIPTION OF THE INVENTION

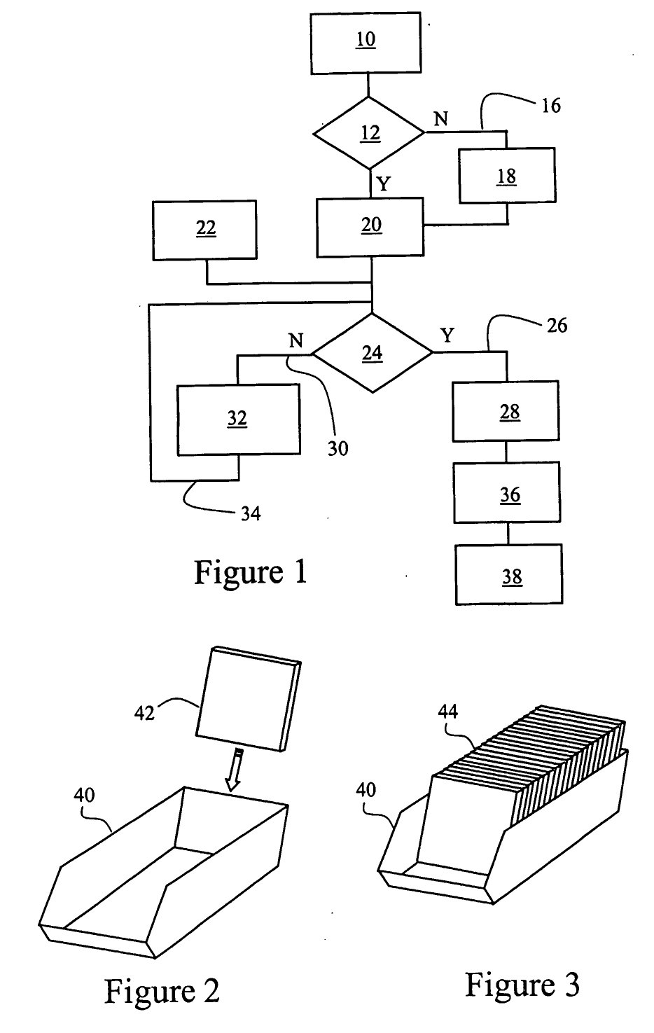

FIG. 1 depicts a flow chart of a mail order fulfillment method (for responding to orders for goods) according to a preferred embodiment of the present invention. According to this method, goods are received 10 at a distribution centre from various sources. In this example, the goods comprise compact disks. The compact disks may be of any type, including prerecorded music, DVD (™) disks, CD-ROMs, and blank compact disks.

These goods are received from a variety of sources, including compact disk distributors and wholesalers. In addition, however, one source of goods will be customers who return one or more compact disks following an evaluation period, or owing to some other reason.

Irrespective of their source, the goods are then identified 12 by barcode reader or the like. If this identification is possible, the method proceeds to step 20. If it is impossible 16 for the automated system to identify the disk, human intervention 18 may be required. In that case, however, according to this method such disks are ejected for later human attention without holding up the processing of other disks. This avoids delaying the processing of disks, and since—according to this method—disks are stored randomly, ejecting a particular disk from the processing stream so that it can be identified by hand, and inserting it back into the stream after some delay, makes no difference to the operation of the method.

Thus, after being identified by human intervention 18, an otherwise unidentifiable disk also proceeds to step 20.

At step 20, the compact disks are grouped into groups of twenty, essentially as they reach this step, each group is placed in a tray, the contents of each group (including the sequence in which the disks were placed in each group) is recorded in a database of a computer, and that tray is automatically allocated to an available storage location within a warehouse portion of the distribution centre, and each tray is then transported to its assigned storage location. The trays are transported either manually or by a conventional automated storage system to their respective storage locations, in the latter case also controlled by the computer.

Alternatively, rather than allocating a storage location to a tray and then transporting that tray to its location, a tray may be transported to a storage location, the location noted and then entered into the database with the other details of that tray (viz. content, etc).

Orders for compact disks are continually received 22 from customers and grouped upon receipt into batches of the same size as the groups of compact disks, viz. twenty in this example. It will be appreciated that a single order may be for one or more disk, but if for more than one that order will simply be treated as though it constitutes multiple, single disk orders.

The orders are then compared 24 by the computer with the contents of the groups of disks, in order to identify a tray whose contents matches the order both in the identification of the compact disks and in the sequence in which the disks appear in the group and in the batch of orders. If a match is found 26, the computer controls the automated storage system to retrieve the matching tray 28.

If no match is found 30, the size of the batch of orders being processed is modified 32. This can be done by reducing the batch size by one by ejecting, for example, the last order of the batch and making it the first order of a subsequent batch of orders (or otherwise moving it to a later point in the sequence of received orders, outside the current batch). Alternatively, it may be preferred simply to swap one of the orders in the batch of orders (such as the last order in the batch) with the first received order (for example) from outside the batch that differs from—in this example—that last order.

In either case, the modified batch is then returned 34 to the comparison step 24, where it is again compared with the existing groups. If the batch was modified by reducing its size, the comparison can now be with any portion of the existing groups. Of course, if a match is found on this basis, the matching group will have at least one unmatched compact disk (since that group will now be greater in size than the batch of orders). These unmatched disks—having already been identified—are directed, according to the method, back to step 20 for placing into new groups of disks.

Once the matching group (or tray) has been retrieved 28, the contents of that tray are packaged and labelled 36 (with customer details) sequentially according to the orders in the batch. The individual packages are then dispatched 38.

FIG. 2 is a view of a typical tray 40 for the compact disks. Each compact disk 42 is placed sequentially into the tray 40 as received by a packing machine after the compact disk has been identified (step 12 in FIG. 1). Referring to FIG. 3, once the tray 40 is full with, in this example, its allocation of twenty disks 44, it is stored (step 20), with its contents and location saved in the database.

This method can also be used in the rental of compact disks or the like. It is found that for disk rentals, a random set of disks are likely to have an 80% match with any random set of requests. According to the present method, twenty-five disks are selected as a reasonably efficient group size. Groups of twenty-five disks are conveniently stored on trays which have spindles that retain the disks in their sequence. Each tray is associated with a specific location on the shelf. New disks are individually barcoded, scanned, and stored on a tray in the order in which they are received. Disks being returned by the members are scanned, and stored on a tray in the order in which they are received. Once a tray is full it is stored in its appropriate location on a shelf.

A computer system stores the details of the members who have returned a disk and stores a manifest of the disks for each tray. The computer system considers the favourites list of each member currently requesting a disk and finds which tray contains the closest to perfect match. The computer system then prints mailing labels in the same order as the disks on the selected tray. The dispatcher takes the nominated tray from its shelf and, using the mailing labels, packages and dispatches the disks.

To store 20,000 disks, a shelf containing 20×40 locations can be used to hold trays of 25 disks each. If at any time this results in a tray that is not full, then the tray can also be put on the shelf holding fewer than 25 disks. If the tray chosen for dispatch is not a perfect match, then the corresponding mailing label can signal this occurrence, and the unmatched disk can be placed on a tray that is treated similarly to the trays of incoming disks.

According to a further preferred embodiment, another mail order method (for responding to orders for goods) according to a preferred embodiment of the present invention is provided. According to this embodiment, goods are again received at a distribution centre from various sources. In this example, the goods comprise DVD (™) disks.

According to this embodiment the disks are stored essentially randomly in an array of carousels, and retrieved in response to an order for specific disks as will be described below.

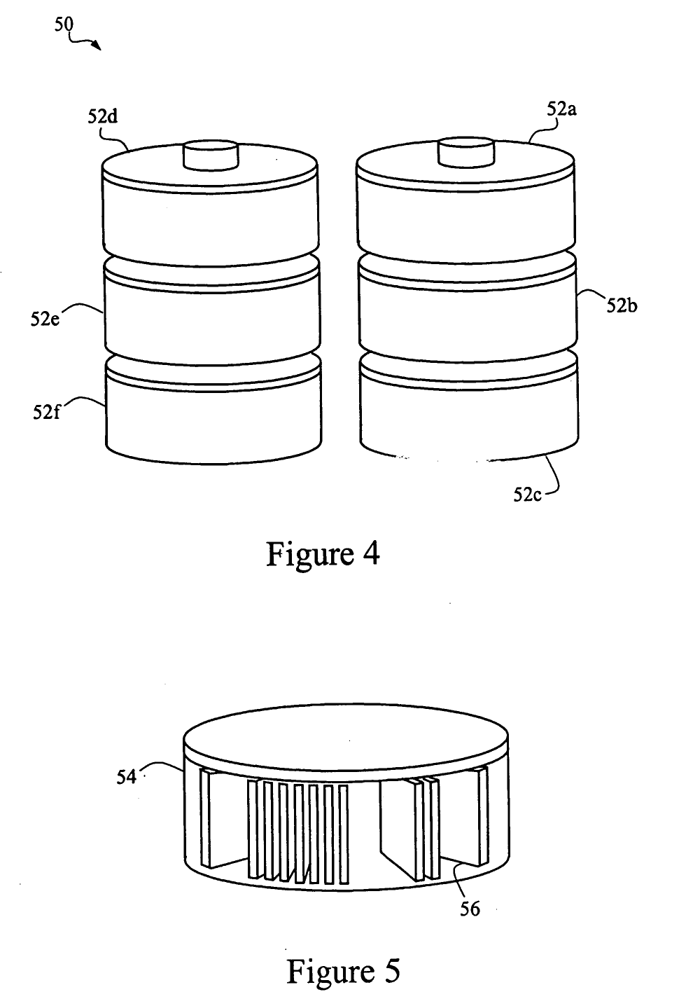

FIG. 4 is a schematic view of an array 50 of disk carousels 52a to 52f. According to this embodiment a number of carousels 52a to 52f are stacked one on another, though this is merely for convenience as it reduces the amount of floor or shelf space required for locating the carousels 52a to 52f. FIG. 5 is an enlarged view of one such carousel 54, shown holding a number or group of disks each in its case (such as exemplary encased disk 56).

The carousels are electronically controlled, and are connected to a control computer (not shown) from which it is possible to identify when a disk is inserted into any of the carousels, and to identify into which carousel and into which slot in that carousel the disk has been inserted.

Similarly, from the computer it is possible to control any of the carousels to partially eject or identify the location of (such as with an LED above the respective slot) any of the disks. This can be done by indicating the location of a desired disk (in terms of carousel identity and slot identity), or by disk content. Thus, an operator can use the computer to request a copy of the motion picture “Citizen Kane”; the computer can be operated to respond to this command by locating where copies of this title are stored and to eject or identify one or more copies. Further criteria are available, as will be discussed below, for selecting which of multiple copies of any particular title should be ejected or identified.

When a batch of disks is received by the distribution centre, they are loaded in whatever order they are received or positioned within each batch into any of the carousels 52a to 52f. This is preferably done by starting with a carousel at one end of the array 50 of carousels and manually inserting as many disks as that carousel will hold before moving to an adjacent carousel. Thus, an operator might start at the top right carousel 52a, and—when that carousel is full—proceed downwards to carousel 52b and carousel 52c, then move to the top left carousel 52d followed by carousel 52e and carousel 52f. This path is simply intended to minimize the movement required by the operator. Importantly, it will be clear that the disks are thereby inserted without concern as to their relative location, or with any intention of grouping disks according to title, subject matter or otherwise.

However, each disk (or, strictly speaking, its case) bears a barcode that identifies the disk's content. Thus, as each disk is inserted into a carousel, the operator scans the barcode by means of a barcode scanner coupled to the computer, so that the computer receives data indicative of the disk's identity. The computer, at the same time, detects that a disk is being inserted in a particular slot of a particular carousel, and saves a data record (for later use) indicating that a disk having the specified content is now stored in the specified carousel and slot. These data, once stored on the computer, can be searched either to identify the disk in a particular slot, or to locate disks with a specified content.

In time, therefore, the carousel array 50 will contain in essentially random order.

When an order is received by the distribution centre, the details of the order are entered into the computer. The computer locates as many of the requested disks on a first carousel (preferably upper right carousel 52a), then as many of the remaining required disks on the next carousel (preferably carousel 52b), and so on until the order has been filled. The operator removes the disks so identified by the computer from each carousel in succession (though it will be understood that some of the carousels may not have any of the disks requested in a particular order). This approach minimizes the time required to physically collect the requested disks from the carousels, as the computer attempts to locate the disks in adjacent carousels. Further, the computer can be programmed to designate any of the carousels as the first carousel, and to determine how many carousels (possibly including intermediate carousels lacking any requested disk) must be approached by the operator. The choice of first carousel leading to the minimum movement by the operator can then be employed, and the requested disks partially ejected or identified to the operator accordingly.

Modifications within the spirit and scope of the invention may be readily effected by those skilled in the art. It is to be understood, therefore, that this invention is not limited to the particular embodiments described by way of example hereinabove.

1. A method of storing and retrieving items, comprising:
grouping said items into one or more groups of said items;
recording the content of each of said groups;
comparing a batch of one or more orders for said items with the recorded content of said groups in order to locate a matching group from said groups that matches said batch or orders; and
retrieving said matching group in order to fill said batch of orders.

2. A method as claimed in claim 1, wherein said groups of items constitute a plurality of sets of groups, each set of groups comprising one or more groups of equal numbers of items.

3. A method as claimed in claim 2, wherein each of said groups has the same number of items.

4. A method as claimed in claim 1, wherein said batch of orders comprises a consecutively received plurality of orders.

5. A method as claimed in claim 1, including locating each of said groups of items in or on a container so that each of said groups can readily be transported until a suitable batch of orders is received and retrieved when a suitable batch of orders has been received.

6. A method as claimed in claim 1, including recording the order of said items in each of said groups, and matching said batch of orders with a matching group on the basis of both the content and sequence of items in said order and in said matching group of said items.

7. A method as claimed in claim 1, wherein, if none of the existing groups of items matches a batch of orders, the method includes reducing the size of said batch of orders until said reduced batch matches a portion of at least one of said groups of items, and deeming said portion of said group of items to constitute said matching group.

8. A method as claimed in claim 7, including subsequently grouping the remaining items of said group with other items to form new groups of said items.

9. A method as claimed in claim 1, wherein, if none of the existing groups of items matches a batch of orders, the method includes replacing at least one of said orders with another order from outside said batch of orders to form a modified batch of orders, and then matching said modified batch of orders with a matching group on the basis of both the content and sequence of items in said order and in said matching group of said items.

10. A method as claimed in claim 1, including optimising the size of said groups.

11. A method as claimed in claim 1, including storing in a computer database data indicative of the incoming items and the location in which each of said incoming item is stored.

12. A method of storing and retrieving items, comprising:
grouping said items into one or more groups of said items;
recording the content of each of said groups;
comparing a batch of orders for said items with the recorded content of said groups in order to locate a matching group from said groups that most closely matches said batch or orders;
retrieving said matching group; and
modifying said matching group if necessary to exactly match said batch of orders;
whereby said batch of orders can be filled.

13. An apparatus for storing and retrieving items, comprising:
data storage means for recording the location and content of each of a plurality of groups of said items;
data processing means for receiving information corresponding to a plurality of orders and for grouping at least some of said orders into a batch of orders and comparing said batch of orders with said contents of said groups of items in order to identify and locate a matching group; and
communication means for communicating the identity of said matching group.

14. An apparatus as claimed in claim 13, including retrieval means for receiving the identity of said matching group from said communication means and retrieving said matching group.

15. An apparatus as claimed in claim 14, wherein said retrieval means is also a storage means, for storing each of said groups of items as directed by said data processing means.

16. A method of storing and retrieving items, comprising:
storing said items into one or more groups of said items;
recording the location of each of said items according to at least group;
comparing an order or orders for a plurality of requested items with said recorded locations; and
locating as many of said requested items as possible in a first of said groups and then, if any requested items are not located in said first of said groups, locating as many previously remaining requested items as possible in each of subsequent ones of said groups;
whereby once all of said requested items have been located, requested items can be retrieved to fill said order or orders.

17. A method as claimed in claim 16, including retrieving said requested items and subsequently treating said retrieved items as no longer stored in any of said groups.

18. A method as claimed in claim 16, including designating the group with the greatest number of the requested items as the first group.

19. A method as claimed in claim 16, including checking said groups sequentially for previously unlocated items, or in an order that maximizes the number of items located in each successive group.

20. A method as claimed in claim 16, including determining for a number of possible assignations of said first group and order of subsequent groups the total number of groups required to locate all of said requested items, and then choosing the assignation of first group and order of subsequent group that either minimizes the total number of groups from which the requested items are retrieved or minimizes the distance required to be travelled between groups to retrieve said requested items.

21. A method as claimed in claim 20, wherein said number of possible assignations of said first group and order of subsequent groups constitutes all possible assignations of said first group and order of subsequent groups.

22. An apparatus for storing and retrieving items, comprising:
one or more storages, each for storing a respective group of said items;
a data storage for recording the location of each of said items according to at least group;
a data processor for comparing an order or orders for a plurality of requested items with said recorded locations, and for locating as many of said requested items as possible in a first of said groups and then, if any requested items are not located in said first of said groups, locating as many previously remaining requested items as possible in each of subsequent ones of said groups;
whereby said apparatus is operable to locate all of said requested items for subsequent retrieval.

23. An apparatus as claimed in claim 22, including a computer having said data storage and said data processor.

24. An apparatus as claimed in claim 22, wherein each of said storages includes a signal means to identify to a user the location of a located item, or an ejector for ejecting a requested item.

25. An apparatus as claimed in claim 22, wherein each of said storages includes a signal means in the form of a lamp to identify to a user the location of a located item.

26. An apparatus as claimed in claim 22, wherein said apparatus is operable to send a data signal to an automated item retriever indicative of the location of a respective requested item, so that said requested items can be retrieved automatically.

27. An apparatus as claimed in claim 22, wherein said data processor is operable to check groups sequentially for previously unlocated items.

28. An apparatus as claimed in claim 22, wherein said data processor is operable to check groups in an order that maximizes the number of items located in each successive group.

29. An apparatus as claimed in claim 22, wherein said data processor is operable to determine a number of possible assignations of said first group and order of subsequent groups, and to choose the assignation of first group and order of subsequent group that either minimizes the total number of groups from which the requested items are retrieved or minimizes the distance to be travelled between groups to retrieve said requested items.

30. An apparatus as claimed in claim 29, wherein said number of possible assignations of said first group and order of subsequent groups constitutes all possible assignations of said first group and order of subsequent groups.

31. A computer readable medium with computer program portions for controlling a computer to perform the method defined claim 1.

32. A computer readable medium with computer program portions for controlling a computer to perform the method defined in claim 12.

33. A computer readable medium with computer program portions for controlling a computer to perform the method defined in claim 16.
